(19) United States
(12) Patent Application Publication
(10) Pub. No.: US 2018/0184687 A1
(43) Pub. Date: Jul. 5, 2018

(54) ANIMAL MANAGEMENT

(71) Applicant: CARGILL, INCORPORATED, Wayzata, MN (US)

(72) Inventors: Chad Conard, Delano, MN (US); Joseph Michael Lewis, Blair, NE (US); Harold Sheldon Norton, Chaska, MN (US); Ricky Allen Stock, Walton, NE (US)

(73) Assignee: CARGILL, INCORPORATED, Wayzata, MN (US)

(21) Appl. No.: 15/908,309

(22) Filed: Feb. 28, 2018

Related U.S. Application Data
(63) Continuation of application No. 13/981,995, filed on Jul. 26, 2013.
(60) Provisional application No. 61/438,811, filed on Feb. 2, 2011.
(60) Provisional application No. 61/437,306, filed on Jan. 28, 2011.

(51) Int. Cl. A23K 20/179; A01K 29/00; A23K 50/00; A23K 10/00

(52) U.S. Cl. CPC A23K 20/179; A23K 10/00; A23K 50/00; A01K 29/005

(57) ABSTRACT

Systems and methods for animal management are disclosed. In one embodiment, a method for managing an animal administering an animal feed ration to a plurality of animals, the animal feed ration comprising ingredients and a taggant. The method also includes visually observing the presence or absence of the taggant adhered to the snout of at least one of the plurality of animals. The method also includes determining if the animal has consumed the animal feed ration.

### CROSS-REFERENCE TO RELATED APPLICATIONS

This application claims benefit of U.S. Patent Application 61/437,306 filed Jan. 28, 2011 and U.S. Patent Application 61/438,811 filed Feb. 2, 2011, which applications are hereby incorporated by reference herein in their entirety.

### TECHNICAL FIELD

The present disclosure relates generally to animal management. Aspects of the disclosure are particularly directed to a method of feeding and managing animals, such as cattle.

### BACKGROUND

It is known to provide a visual marker for monitoring a human patient to determine compliance with a medication regimen. For example, U.S. Pat. No. 7,062,312 titled “Combination and Method Including a Visual Marker for Determining Compliance with a Medication Regimen” issued Jun. 13, 2006 to Gilbert R. Gonzales and assigned to Pediamed Pharmaceuticals Inc. discloses an orally administrable medication combined with a visual marker, so that when the combination is orally ingested, the marker causes a coloration or discoloration of the oral and/or pharyngeal cavity of a subject. By visually observing the oral and/or pharyngeal cavity of the subject, one can determine whether medication has been ingested based upon the presence or absence of the coloration/discoloration.

It is also known to evaluate vaccines mass administered to chickens through drinking water or spray by the addition of a blue dye where the dye is used in order to monitor the consumption of the vaccine by the birds by temporarily staining the tongues of the birds as described in U.S. Patent Application Publication No. US20060171960A1 titled “Methods and Composition for Oral Vaccination” published Aug. 3, 2006 to Hsien Jue Chu and assigned to Wyeth. It is also known to provide a water soluble blue dye to evaluate and monitor water vaccination technique. The blue dye has the ability to mark birds having consumed vaccine solution by temporarily staining their tongues, as described in “Drinking Water Vaccination” by Dr. T. Cserep published in Datafile by Intervet Poultry Division bearing designations “08143/08/02” and “© 2002 Intervet UK Limited”.

It is also known to provide feeds having some of the particles being of one color and the other particles being of another color as described in U.S. Pat. No. 2,685,517 issued Aug. 3, 1954 to Russell P. Dunmire and assigned to Nutrition Products, Inc. It is also known to incorporate color into animal feed to stimulate feed consumption as described in U.S. Patent Publication No. US20080260892A1 titled “Animal Feed” published Oct. 23, 2008 to Rae Fisher and assigned to Fisher Feeds Ltd. It is also known to increase the visual attractiveness of the feed to the animals resulting in improved feed uptake and feed utilization by the animal as described in U.S. Patent Publication No. US20070298149A1 titled “Animal Feedstuff Dyeing and Animal Drugs” published Dec. 27, 2007 to Ralf Schweinfurth. It is also known to incorporate color into animal feed supplements such as, for example, RIGHT NOW® Minerals (Cargill, Incorporated, Minnetonka Minn.) to facilitate appropriate product selection by purchaser according to the growing season, forage conditions, and nutritional needs of cattle.

Cattle encounter significant stresses during transportation to a feedlot, which can negatively impact their appetites. One of the biggest problems facing cattle feedlot operators is getting cattle to eat once they arrive at the feedlot. When cattle arrive at the feedlot, they need a diet that is high in energy and protein to regain muscle tissue and stimulate microbial growth in the rumen. It is difficult to identify the few cattle that are hesitant to eat when they arrive at the feedlot. Accordingly, it would be advantageous to provide for a system and method which provides feedlot operators a way to quickly single out feedlot cattle that are not consuming feed and that might need extra attention or different management techniques.

### SUMMARY

Disclosed herein are systems and methods for animal management.

In one aspect, provided is a method for managing an animal, comprising the steps of:
(i) administering an animal feed ration to a plurality of animals, the animal feed ration comprising ingredients and a taggant;
(ii) visually observing the presence or absence of the taggant adhered to the snout of at least one of the plurality of animals; and
(iii) determining if the animal has consumed the animal feed ration.

In some embodiments, the method further comprises the step of adhering the taggant to the exterior snout of the animal when the animal consumes the animal feed ration. In some embodiments, the method further comprises the step of adhering the taggant to at least one of the nose and mouth of the animal. In some embodiments, the method further comprises the step of managing the animal after determining if the animal consumed the feed. In some embodiments, managing the animal includes individually managing the animal or managing the animal as a member of the plurality of animals. In some embodiments, individually managing the animal includes removing the animal from the plurality of animals.

In some embodiments, the taggant is a marker. In some embodiments, the taggant is one or more dyes. In some embodiments, the taggant has a color that is visible or distinguishable. In some embodiments, the taggant is one or more dyes selected from the group consisting of indigo carmine, methylene blue, tartrazine, laccaic acid, beta-carotene, FD&C Blue No. 1, FD&C Blue No. 2, FD&C Green No. 3, FD&C Red No. 3, FD&C Red No. 40, FD&C Yellow No. 6, and riboflavin. In some embodiments, the color is in the visible spectrum of 700-400 nm. In some embodiments, the color is at least one of red, orange, yellow, green, blue, indigo, pink, black, gray, white, and violet. In some embodiments, the color is different from the predominant color of the ingredients of the animal feed ration.

In some embodiments, the ingredients comprise a high moisture feed, roughage, and micro ingredients. In some embodiments, the high moisture feed comprises corn gluten feed, and the roughage comprises at least one of alfalfa hay and cottonseed hulls. In some embodiments, the corn gluten feed, and the roughage comprises about 75-90 wt % by weight, the at least one of alfalfa hay and cottonseed hulls comprises about 5-20 wt %, and the micro ingredients comprises 2-3 wt %. In some embodiments, the ingredients comprise nutrients, and the nutrients comprise protein, fat, fiber, and acid detergent fiber (ADF). In some embodiments, the nutrients further comprise crude protein in the amount of at least 13 wt %, crude fat in the amount of at least 1.5 wt %, crude fiber in the amount of no more that 9.0 wt %, ADF in the amount of no more than 12.0 wt %, calcium in the amount of about 0.065 to about 1.15 wt %, and phosphorus in the amount of at least 0.50 wt %.

In some embodiments, administering the feed comprises orally feeding the animal. In some embodiments, the feed is a solid feed. In some embodiments, the feed is a non-liquid feed. In some embodiments, the feed is a complete feed. In some embodiments, the feed is a starter feed. In some embodiments, the animal has a ruminal pH higher than that of an animal fed a steam-flaked corn and alfalfa hay starter diet. The method of claim 23, wherein animal feed intake is at least about 2% higher than that of an animal fed a steam-flaked corn and alfalfa hay starter diet. The method of claim 23, wherein animal weight gain is higher than that of an animal fed a steam-flaked corn and alfalfa hay starter diet.

In some embodiments, the animal comprises at least one of bovine, ovine, porcine, equine, poultry, and reptile. In some embodiments, the animal comprises a beef steer managed in a feedlot as a group or as an individual. In some embodiments the method further comprises visually observing the presence or absence of the taggant in the excrement of at least one of the plurality of animals. In some embodiments, the feed comprises less than about 2% calcium.

### BRIEF DESCRIPTION OF THE DRAWINGS

FIG. 1 is color photograph of a steer whose nose has been tagged according to an exemplary embodiment of the present invention.

FIG. 2 is a color photograph of a steer whose nose has been tagged according to an exemplary embodiment of the present invention.

FIGS. 3A-3I is a series of color photographs of a pig whose snout and head have been tagged according to an exemplary embodiment of the present invention.

FIGS. 4A-4C is a series of color photographs of feces from a pig that has been tagged according to an exemplary embodiment of the present invention.

FIG. 5 is a graph showing rumen acid levels for calves fed traditional starter feed or RAMP® starter feed during Period 1.

FIG. 6 is a graph showing rumen acid levels for calves fed traditional starter feed or RAMP® starter feed during Period 2.

FIG. 7 is a graph showing dry matter intake for calves fed traditional starter feed or RAMP® starter feed during Period 1.

FIG. 8 is a graph showing dry matter intake for calves fed traditional starter feed or RAMP® starter feed during Period 2.

### DETAILED DESCRIPTION

Specific details of several embodiments of the disclosure are described below with reference to an animal management system. One aspect of the present disclosure is directed toward a method for managing an animal which includes administering an animal feed ration, comprising ingredients and a taggant, to a plurality of animals. The method also includes visually observing the presence or absence of the taggant adhered to the snout of at least one of the plurality of animals. The method also includes determining if the animal has consumed the animal feed ration.

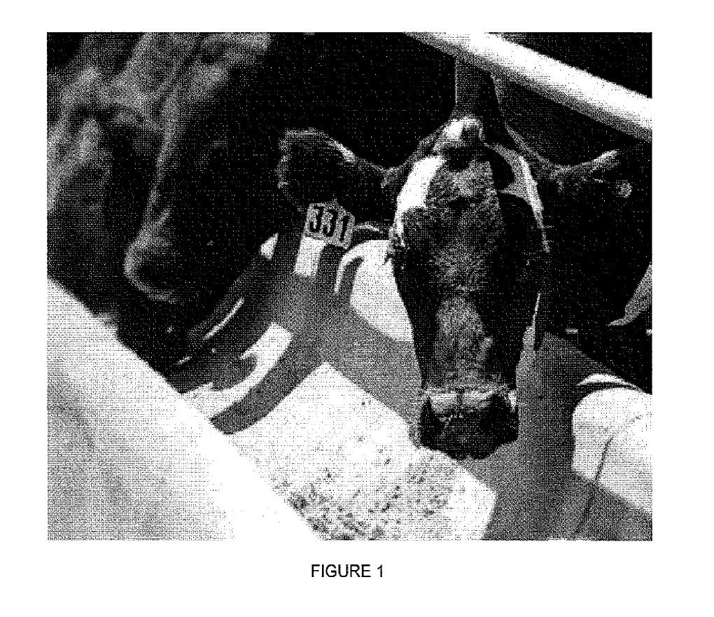

Referring to FIG. 1, cattle (shown as a steer with ear tag 331) is shown eating an animal feed ration in a feed trough. The exterior of the snout or nose of steer 331 is shown colored green (the same color as the feed in the trough). The snout is marked with a taggant or dye in the feed ration, which visually indicates steer 331 has consumed the feed ration. (If the marking was absent on the snout or nose of the steer (or in the excrement), it would indicate the steer did not consume the feed ration.)

The term “animal feed ration” as used herein refers to complete feed, supplemental feed, or the combination of a base animal feed and an admixture containing particular low-inclusion ingredients (e.g., micro ingredients such as vitamins and minerals). A “base animal feed” as used herein generally refers to a ration that contains any of the various cereal grains, their by-products, and other sources of primary nutrition (fat, fiber, and protein) such as, but not limited to, barley, blood meal, bone meal, Brewer's grain, corn grain, corn gluten meal, corn gluten feed, cottonseed (e.g., whole or meal), distillers grain, fish meal, hominy, feather meal, molasses, peanut skins, soybeans (e.g., whole or meal), tallow, and wheat (e.g., whole, bran or middlings). An animal feed ration as used herein can be formulated for pigs, cattle, horses, poultry, various domestic pets, and any other animal (e.g., a livestock animal, a pet, a companion animal, etc.). The animal feed ration may be used in several forms: complete feed form, concentrate form, blended form, base mix form, meal feed, pelleted feed, roughage, total mixed rations, high moisture feed, or extruded feed. A “complete feed” is a nutritionally adequate feed for animals other than humans, and the specific formula is compounded to be fed as the sole ration and is capable of maintaining life and/or promoting production without any additional substance being consumed except water. An example of the complete feed form can include wheat middlings, corn, soybean meal, corn gluten meal, distillers grains or distillers grains with solubles, blood meal, salt, macro-minerals, trace minerals, and vitamins. A “supplement” is a feed used with another feed to improve the nutritive balance or performance of the total. A supplement is intended to be fed undiluted as a supplement to other feeds, or offered free choice with other parts of the ration separately available, or further diluted and mixed to produce a complete feed.

The animal feed ration includes ingredients (e.g., processed grain products, soybean meal, etc.) that provide nutrients (e.g., protein, fat, etc.). According to a preferred embodiment, the ingredients of the animal feed ration can include a high moisture feed (e.g., corn gluten feed), roughage, and/or micro ingredients.

According to a preferred embodiment, the high-moisture feed is processed grain by-products resulting from the processing of a number of different grains such as corn, wheat, and Milo (grain sorghum). Examples of high-moisture processed grain by-products include, without limitation, gluten, non-grain feed ingredients (e.g., molasses, beet pulp and other crop residues), and distillers grain. According to a preferred embodiment, the high-moisture processed grain by-product is a commercial product marketed under the trade name SWEET BRAN® feed commercially available from Cargill, Incorporated of Minnetonka Minn. SWEET BRAN® feed is a corn gluten feed (“CGF”) product produced by the wet corn milling process. SWEET BRAN® feed has a controlled formula containing corn bran, corn steep liquor, and germ meal and is produced from the wet corn milling process.

The primary goal of the wet corn milling process is to separate the starch from the kernel. In the United States, only #1 or #2 grade corn is typically used in the wet-milling process. According to the process, corn is screened to remove crop residue, fines, and broken kernels, and is steeped in a dilute sulfurous dioxide solution for 40 to 48 hours. Through a series of grinds, differential separations, and centrifuges, the kernel fractions are separated. The primary component to be isolated is starch. Starch may be dried and sold as-is or converted to a wide variety of products, including corn syrups and high fructose corn sweetener. Some wet corn milling plants convert starch to dextrose, which is then used as an energy source for various microbial fermentations. Dextrose may also be fermented by yeast to fuel ethanol. A feed by-product of the alcohol production is distillers solubles. Distillers solubles produced by the wet-milling industry contain yeast cells and unfermented sugars, and may not contain high levels of fat.

Another fraction that is separated in the wet-milling process is corn germ. Corn germ is separated, dried, and sent to a germ plant for extraction of the corn oil. After the oil is extracted, the remaining feed by-product is called corn germ meal. Corn gluten meal is also separated during the wet-milling process. Corn gluten meal is high in crude protein and escape protein. Today, very limited quantities of corn gluten meal are found in CGF.

The remaining fractions are bran and steep liquor (i.e., liquid separated after steeping). Bran and steep liquor are the major components of CGF. During the separation process, bran is pressed to remove much of the water. Pressed wet bran usually contains approximately 40% Dry Matter (“DM”). Steep liquor and distillers solubles are either evaporated separately or together to approximately 40 to 50% DM. The CGF produced is a wet by-product according to a particularly preferred embodiment.

In most cases, the wet bran cannot absorb all of the steep that is produced by the plant, requiring some of the steep to be dried and sold with CGF pellets or requiring a portion of the plant's steep production to be sold as a separate feed ingredient. Consequently, wet CGF may vary in crude protein (“CP”) content (about 14 to 24%, DM basis) from plant to plant because varying amounts of steep are being added to the wet bran. Thus, the type of wet CGF produced differs among wet-milling plants. Some wet-milling plants pre-dry the wet bran to 85% DM before adding the steep, thereby increasing the proportion of steep in the wet CGF. Therefore, CGF does not have a consistent nutrient profile among wet-milling plants. In summary, CGF may be sold wet (about 40 to 60% DM) or dry, and it may contain various quantities of bran, steep liquor, distillers solubles, germ meal, and cracked corn screenings, as well as minor quantities of end-products from other microbial fermentations.

The animal feed ration may also include roughage. Roughage is plant material (mainly plant leaves and stems) eaten by grazing livestock. Roughage (also referred to as “forage”) includes plants eaten by animals directly as pasture, crop residue, or immature cereal crops, and also includes similar plants cut for fodder and carried to the animals, especially as haylage or silage. According to a preferred embodiment, the roughage of the animal feed is alfalfa hay and/or cottonseed hulls. Roughage may also include grasses, herbaceous legumes (e.g., alfalfa), tree legumes, silage (e.g., corn (maize), alfalfa, grass-legume mix, sorghums, oats) and crop residue (e.g., corn (maize) stover, soybean stover, wheat straw).

The animal feed ration also includes an admixture such as micro ingredients, commonly referred to as feed additives (e.g., vitamins, minerals, supplements, health additives, etc.). The inclusion of various micro ingredients into the feed ration assists in achieving optimal animal health and productivity. Feed additives can be used, for example, to help provide a balanced diet (e.g., vitamins and/or trace minerals), to protect the animals from disease and/or stress (e.g., antibiotics, probiotics) and/or to stimulate or control growth and behavior (e.g., hormones). Feed additives or supplements generally are administered to each animal or groups of animals on a regular basis in carefully controlled dosages, oftentimes very small dosages, to ensure optimal benefit. Such additives generally are considered to be low-inclusion ingredients. Low-inclusion ingredients are defined as those ingredients that constitute less than about 1% to 2% of the total feed ration. Low-inclusion ingredients include, without limitation, ionophores, lasalocid, monensin, antibiotics (e.g., chlortetracycline (“CTC”), oxytetracycline, bacitrain, tylosin, aureomycin), probiotics and yeast cultures, vitamins, trace minerals (e.g., Cu, Zn, Fe, Se), macro minerals (e.g., Ca, P, Mg, K), coccidiostats (e.g., amprollium, decoquinate, lasalocid, monensin), and hormones (e.g., growth hormones or hormones that inhibit estrus and/or ovulation such as melengestrol acetate). Low inclusion ingredients also can include pheromones, nutraceuticals, pharmaceuticals, flavanoids, nutritive and non-nutritive supplements (e.g., minerals in a specific form), and detoxicants. Some commercially-available low-inclusion ingredients are sold under the trade names RUMENSIN®, BOVATEC®, DECCOX®, TYLAN®, OPTAFLEXX®, and MGA®. Low-inclusion ingredients can be, for example, in granular, powdered, liquid, or microencapsulated form.

The animal feed ration includes a taggant (e.g., dye or marker). The taggant changes the color of the base feed. In certain preferred embodiments, the taggant is a dye (or combination of dyes). The dye changes the color of the base feed. The dyes should provide a visually detectable coloration or discoloration of the feed (e.g., in the visible spectrum of 700-400 nm having a color of red, orange, yellow, green, blue, indigo and violet) under natural light. Dyes approved by AAFCO for use in animal feed or by the U.S. Food and Drug Administration are acceptable. Suitable dyes include: (i) dye no. 06507 Fast Emerald Green water soluble powder containing FD&C Yellow #5 and FD&C Blue #1 commercially available from Sensient Colors Inc. of St. Louis, Mo.; (ii) dye no. 05700 FD&C Blue #1 DM FDA/EC a water soluble particulate with a characteristic hue when dissolved and viewed in a 10 ppm water solution and commercially available from Sensient Colors Inc. of St. Louis, Mo.; (iii) dye no. 07700 FD&C Red #40 Powder DM FDA/EC a reddish-brown, water soluble powder with a characteristic hue when dissolved and viewed in a 10 ppm water solution and commercially available from Sensient Colors Inc. of St. Louis, Mo.; (iv) dye no. 07704 FD&C Red #40 Powder Granular DM2000 FDA/EC a water soluble color particulate with a characteristic hue when dissolved and viewed in a 10 ppm water solution and commercially available from Sensient Colors Inc. of St. Louis, Mo.; (v) dye no. 05602 FD&C Blue #2 Powder FDA/EC a reddish-blue water soluble powder with a characteristic hue when dissolved and viewed in a 10 ppm water solution and commercially available from Sensient Colors Inc. of St. Louis, Mo.; and (vi) dye no. CSL3991 Buff Yellow Shade containing FD&C Yellow #5, FD&C Yellow #6, and FD&C Red #40 commercially available from Sensient Colors Inc. of St. Louis, Mo. In alternative embodiments, other dyes can be used as taggants. Such dyes may include, without limitation, indigo carmine, methylene blue, tartrazine, laccaic acid, beta-carotene, FD&C blue #1, FD&C blue #2, FD&C green #3, FD&C red #3, FD&C red #40, FD&C yellow #6, and riboflavin.

In some embodiments, the taggant may include a water-activated dye, a saliva-activated dye, or mixtures thereof.

A relatively small amount of the taggant may be added to the animal feed ration. For example 110 ppm taggant (e.g., 0.2 lbs of taggant per ton of feed) and 55 ppm taggant (e.g., 0.1 lbs taggant per ton of feed) may be sufficient. About 0.02 wt % taggant is preferred. In other alternative embodiments, the taggant may be about 75 ppm to about 150 ppm (0.3 lbs of taggant per ton of feed). In some embodiments, the taggant may be coated on the outer surface of a pellet formed from the animal feed ration by, for example, spraying a taggant solution onto the pellets.

The color of the animal feed ration may be measured at different concentrations of the taggant, using a Hunter Colorimeter (Hunter Associates Laboratory, Inc, Reston, Va.) as shown in TABLE 1.

TABLE 1
Color Scale

| Red ppm | L | a | b |
|---|---|---|---|
| 50 | 48.8 | 18.55 | 26.35 |
| 75 | 48.1 | 19.25 | 25.6 |
| 150 | 46.3 | 21.7 | 24.1 |
| 300 | 42.7 | 27.75 | 22.75 |
| 1500 | 35.1 | 35.65 | 19.7 |

The values in TABLE 1 represent the color scale for the colorimeter. The “L” value measures the white/black in the sample, while the “a” measures red/green, and “b” measures blue/green. As shown in TABLE 1, there is not a large difference in color of the “a” values between 50 ppm and 150 ppm, however the appearance of the samples would be greatly noticeable by the naked eye. The results shown in TABLE 1 show an increase in color when taggant concentrations were compared between 50 ppm and 1500 ppm.

According to a preferred embodiment, the feed is a starter feed. A starter feed is intended for young animals, which may have unique nutrient requirements. The composition of the starter feed depends on the needs of the animal. The goal is to deliver the optimal nutritional levels for a good health and the maximum animal weight gain. Some starter feeds may have a mixture of highly digestible protein products, probiotics, acidifiers, enzymes and palatability agents (flavors and sweeteners). Young animals face unique feeding challenges. For example, a young animal may be developing its digestive and enzymatic systems, together with the additional necessity of growth in this period and the reduction of the maternal immunity. The starter feed may contribute to much higher results on animal performance (growth, nutritional, and sanitary) later in life. According to a preferred embodiment, the animal feed ration is a high moisture solid (non-liquid). According to alternative embodiments, the feed is a complete feed, a compound feed, or a premix.

In some embodiments, the animal feed ration may include the following ingredient inclusions as fed (% by weight): (i) about 60% to about 85% corn gluten feed; (ii) about 5% to about 20% roughage (i.e., alfalfa hay and cottonseed hulls); (iii) about 2% to about 3% minerals and vitamins; and (iv) taggant (i.e., FD&C Blue #1).

According to a preferred embodiment, the animal feed ration includes the following ingredient inclusions as fed (% by weight): (i) about 75% to about 90% corn gluten feed; (ii) about 5% to about 20% roughage (i.e., alfalfa hay and cottonseed hulls); (iii) about 2% to about 3% minerals and vitamins; and (iv) taggant (i.e., FD&C Blue #1).

In some embodiments, the animal feed ration may include the following ingredients and nutrients inclusions as fed (% by weight): (i) crude protein (about 10% to about 30%); (ii) crude fat (about 1% to about 9%); (iii) crude fiber (about 2% to about 20%); (iv) calcium about 0% to about 2%); (v) phosphorus (about 0.5% to about 1%); (vi) taggant (i.e., FD&C Blue #1; about 25 ppm to about 200 ppm or about 50 ppm to about 75 ppm). In some embodiments, the animal feed ration may have a dry matter content of about 30% to about 95% DM, about 30% to about 70% DM, about 40% to about 60% DM, or about 80% to about 95% DM, and about 5% to about 70% moisture, about 30% to about 70% moisture, about 40% to about 60% moisture, or about 5% to about 20% moisture. In a preferred embodiment, the animal feed ration may have a dry matter content of about 57% to about 65% DM and about 35% to about 43% moisture.

According to a particularly preferred embodiment, the animal feed ration includes the following ingredients and nutrients inclusions as fed (% by weight): (i) crude protein (minimum 13%); (ii) crude fat (minimum 1.5%); (iii) crude fiber (maximum 9.0%); (iv) acid detergent fiber (maximum 12.0%); (v) calcium (minimum 0.065%); (vi) calcium (maximum 1.15%); (vii) phosphorus (minimum 0.50%); (viii) taggant (i.e., FD&C Blue #1). According to a particularly preferred embodiment, the animal feed ration has a dry matter content of about 58.5-61.5% DM, and 41.5-38.5% moisture.

In some embodiments, the animal feed ration may be in the form of a meal feed. Meal feed preparation processes are known to those skilled in the relevant arts and may consist of using commercial feed manufacturing equipment for the purpose of mixing a final meal feed product. The mixing process may consist of weighing bagged or bulk ingredients. The bagged ingredients may be weighed on a small platform scale and put into a container for use later in the mixing process. The bulk ingredients may be weighed on a major ingredient scale, and then discharged into a horizontal ribbon mixer along with the bagged ingredients previously weighed. Once the ingredients are delivered to the mixer, they may be mixed for a timed period (e.g., about 1 to about 10 minutes), followed by addition of any liquid ingredients into the mixer, and the total batch may be mixed for an additional time period (e.g., about 1 to about 10 minutes) adequate for preparation of a homogenous mixture of the meal feed. The meal feed may be delivered to a bin for storage until the meal feed is ready to be loaded onto trucks or placed in bags for delivery to the customer.

In some embodiments, the animal feed ration may be in the form of a pellet or pellets. Feed pelleting processes are known to those skilled in the relevant arts and may consist of using commercial feed manufacturing equipment for the purpose of mixing and pelleting a final product. The mixing process may consist of weighing bagged or bulk ingredients. The bagged ingredients may be weighed on a small platform scale and put into a container for use later in the mixing process. The bulk ingredients may be weighed on a major ingredient scale, and then discharged into a horizontal ribbon mixer along with the bagged ingredients previously weighed. Once the ingredients are delivered to the mixer, they may be mixed for a timed period (e.g., about 1 to about 10 minutes), followed by addition of any liquid ingredients into the mixer, and the total batch may be mixed for an additional time period (e.g., about 1 to about 10 minutes) adequate for preparation of a homogenous mixture.

The mixture may next be discharged from the mixer into a surge hopper and then may be discharged from the surge hopper to a bucket elevator, which elevates the mixed product to a holding bin above the pelleting equipment. To start the pelleting process, the blended mixture may be conveyed by the use of a feeder auger which regulates the flow rate to the rest of the pelleting system. The feeder auger may deliver the blended mixture to a conditioner if added moisture and/or elevated temperatures are desired. The conditioner may convey the mixture to the feed chute, which can deliver the product into the pellet chamber of the pellet mill. In the chamber portion of the pellet mill, typically there are roller assemblies which run in a close, fixed position in relation to the pellet die. The pellet die may be, for example, a die with a square profile or a round profile. Typically the die turns inside the pellet chamber, and the roller assemblies are stationary on their shaft but turn with the die which turns out the outside of the die chamber, with the roller assemblies on the inside of the chamber. The compression of the mixture may be achieved by the mixture being placed between the roller assemblies and the inner die surface, which may compress the mixture through the holes located in the die. This process can form the pelleted form of the product.

As the pellet is discharged through the die, the pellet may drop through a spout and into a commercial pellet cooler. In some embodiments, a counterflow cooler, which consists of a horizontal bed which holds the pellets discharged from the pellet mills, may be used. The design of the counterflow cooler allows air to be drawn through the bed of pellets which is deposited inside the cooler. The level of the pellets may be maintained at a fixed level, which can allow for the pellets to be retained in the cooler until they have reached a cooled temperature (e.g., a temperature relatively close to the ambient temperature of the air being drawn through the cooler). When the level of the pellets in the cooler reaches a predetermined level, the pellet cooler may discharge until the pellet level drops below a predetermined level.

As the pellets discharge from the cooler, they may drop into a hopper below the cooler, where they may conveyed by a drag conveyor into a bucket elevator which elevates the finished product to a distributor. The distributor may be used to select which bulk bin the pellets are delivered to for storage until the pellets are ready to be loaded onto trucks or placed in bags for delivery to the customer.

In some embodiments, the feed pellets may have a round profile. In some embodiments, the feed pellets may have a diameter of about 2.5 mm to about 6.5 mm. In some embodiments, the feed pellets may have a length of about 6 mm to about 25 mm. In some embodiments, the feed pellets may have a moisture content of about 5% to about 20%.

In another embodiment, the animal feed ration may be a high-moisture feed ration, such as, for example, RAMP® (Cargill, Incorporated, Minnetonka, Minn.), where the various ingredients that comprise the final ration are mixed in a large batch mixer with the addition of water soluble taggant (e.g., a dye) for about 30 seconds to about 2 minutes and where the 20-40% water in the ingredients allows the taggant to go into solution and uniformly alter the color of the mixture and also make the “marking effect” on the animal more apparent. In the mixing process, the feed ingredients are typically transferred from storage by various conveyors, added to a mixer by weight per a prescribed formulation and mixed. From the mixer the feed is transferred directly to the delivery vehicle (e.g., a tractor/trailer) and delivered to a customer, where the feed is transferred to feed bunks and made available to animals for consumption.

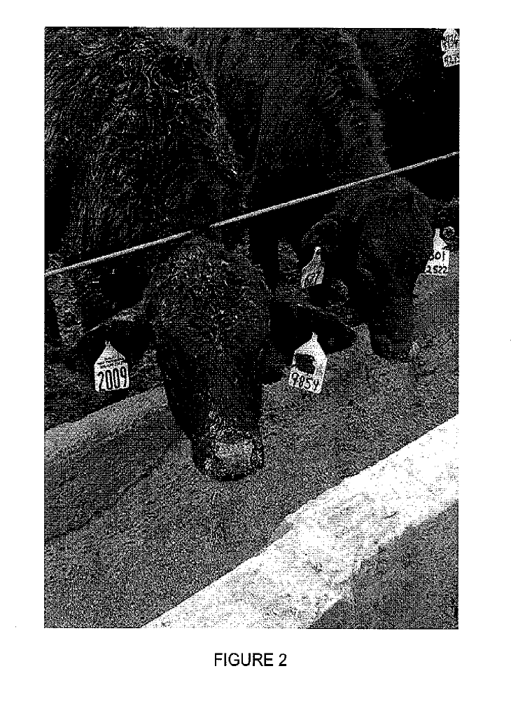

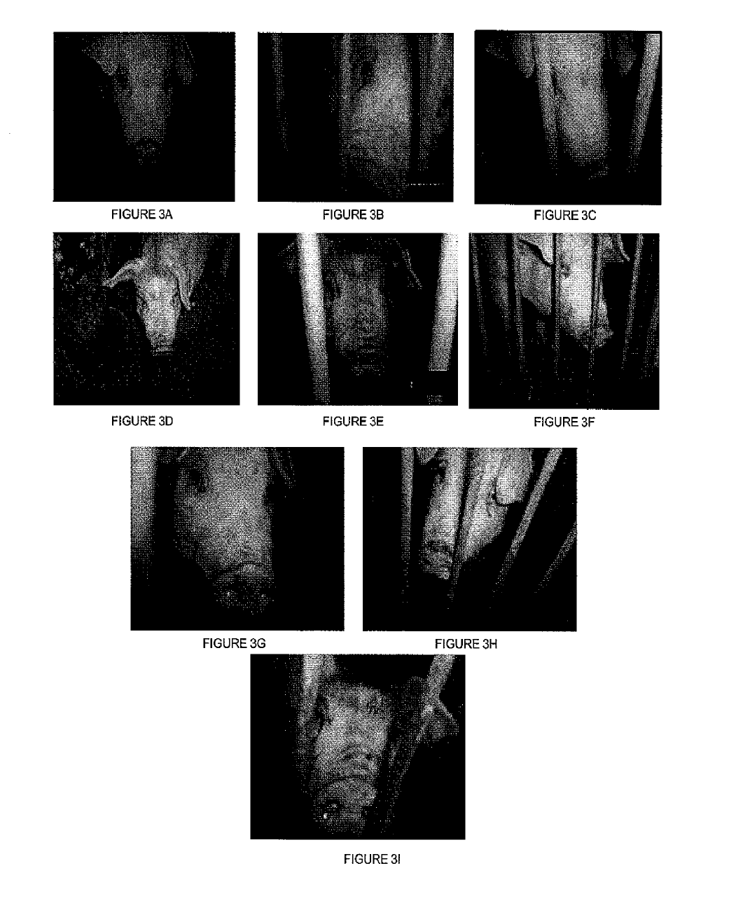

When the animal consumes the animal feed ration which has been colored by the taggant, the colored feed itself may attach to the exterior snout of the animal. Referring to FIG. 2, cattle are shown being fed a green-colored animal feed ration. A steer (with an ear tag 9854) and a steer (with an ear tag 627) are shown with the animal feed ration attached (e.g., adhered, cleaved, sticking fast) to the snout of the animals. These dissimilar substances (feed and snout) are united by molecular force acting in the area of contact between the snout and the feed. Referring to FIGS. 3A-3I, a pig is shown having consumed the green-colored feed ration over time. In these FIGURES, the taggant from the feed (rather than the ingredients of the feed such as high moisture corn gluten feed, roughage, and micro ingredients) has dyed the nose and the head of the pig.

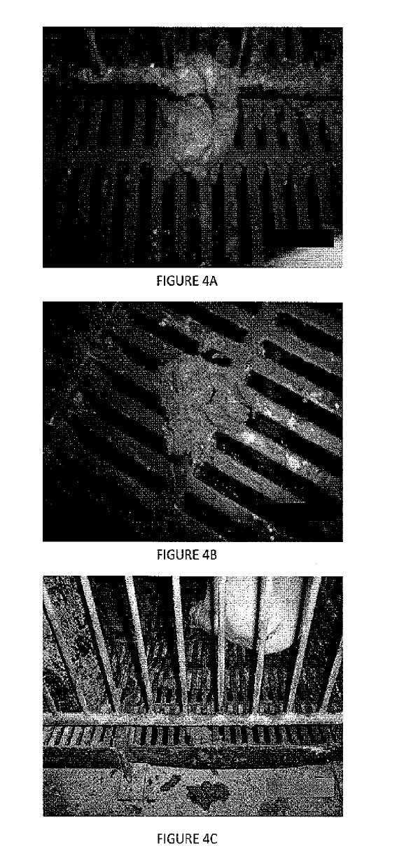

Referring to FIGS. 4A-4C excrement or feces from an animal who has consumed the feed ration is shown according to an alternative embodiment. The excrement is shown colored green (the same color as the feed ration consumed). The excrement is marked with the taggant, which also visually indicates the animal has consumed the feed ration. Investigation and monitoring of the excrement may be especially useful for animals that are traditionally individually penned (e.g., pigs, dairy cattle, etc.). Investigation and monitoring of the excrement may also be useful for animals permitted to forage, to determine if individual animals consumed specific ingredients (e.g., mineral supplements) while foraging.

According to a preferred embodiment, the taggant will dissipate (e.g., disappear, evanesce, etc.) from the exterior of the animal shortly after consumption of the colored feed (e.g., before the next feeding, 6 hours, 3 hours, 2 hours, 1 hour, etc.). In this way, the animal (and/or its excrement) would be re-marked at the next feeding of the colored animal feed. According to another preferred embodiment, the marking will correspond to a one-time event (e.g., after transportation of an animal) and may mark the animal (and/or its excrement) for a longer duration (e.g., 1-3 days). In this way, the animal (and/or its excrement) would be marked to ensure it has begun to eat after said event.

When eating the colored animal feed, some animals (such as cattle) will have their nose substantially marked by the feed. For example, referring to FIG. 2, the steer with ear tag 9854 is shown having the exterior of its nose substantially covered with feed having the green color. The steer with ear tag 627 is shown licking the feed and its nose, thereby further marking the exterior of its snout with the green-colored feed. Animals which have not eaten or otherwise not come in contact with such feed will not be marked by the feed in this way (i.e., the coloration in the area of interest on the animal (e.g., snout) will be absent). Other animals (such as pigs) may have multiple areas of their body marked by the feed (e.g., nose, snout, head, body, legs, etc.). For example, referring to FIGS. 3A-3I, a pig is shown having consumed the green-colored feed ration. Only a portion of the nose and snout of the pig is dyed from the feed in FIG. 3A. In FIG. 3H, the exterior snout of the pig is shown dyed from the feed, and the nose is substantially undyed. In FIG. 3E a large portion of the exterior snout of the pig is shown dyed by the feed. According to alternative embodiments, the feed or the dye may cover or mark less than substantially the entire nose or snout of the animal (e.g. 90%, 80%, 70%, 60%, 50%, 40%, 30%, 10% or less coverage relative to the surface are of the entire body part of interest).

If the animal has actually eaten the feed, then the exterior snout of the animal or nose of the animal will be stained with a color indicative of the taggant according to a preferred embodiment. By periodically observing the snout for this coloration (and/or the excrement of the animal), one can determine whether an animal has eaten the feed. Thus, if no coloration is apparent (i.e., the absence of marking) upon observation of the snout (and/or its excrement), an animal manager (e.g., feedlot manager, nutritionist, veterinarian, etc.) can require additional animal management steps. Such additional animal management steps may include grouping like animals (e.g., all animals have a similar size or weight) and managing the animals as a group or lot (e.g., treating all animals the same, feeding all animals the same ration, etc.). Such additional animal management steps may also include segregating certain animals (i.e., those individual animals which have not been marked by the feed) and managing those animals individually (e.g., individual treatments, individual feeding regimes, individual diets, etc.).

Various visual inspection methods might be used to determine if the snout of the animal (and/or the excrement of the animal) has been colored by the feed. For example, the coloration might be detected under natural light with the naked eye. According to an alternative embodiment, fluorescence of the snout could be detected using a fluorescent light. The light, which would be selected for its optimal wavelength, would evoke a visually apparent emission of fluorescence of a characteristic color for the particular marker used. The fluorescence might remain detectable for a period longer than the marker's natural coloration, such that inspection may be made after the marker coloration is no longer significantly visible to the naked eye under natural light conditions. While the naked eye should be sufficient for detection purposes, the present invention does not preclude the use of optical instruments or other detection instrumentation.

Traditional starter diets typically contain roughage, such as alfalfa hay, and processed grain, such as steam-flaked corn. Hay and grain differ in density and can easily be separated from the mixed ration by cattle. When separation of dietary ingredients occurs, the cattle that consume the hay have a high ruminal pH, and consume less digestible energy, resulting in reduced animal gains. When separation of dietary ingredients occurs, the cattle that consume the grain may have low ruminal pH and may have reduced rumen health, resulting in reduced animal weight gains. Cattle fed a diet in which grain and hay are replaced with a highly-digestible fiber source may have a stable ruminal pH with good ruminal health and consume a large amount of digestible energy, resulting in increased weight gain.

In some embodiments, an animal fed an animal feed ration of the present disclosure as a starting diet may have a ruminal pH higher than that of an animal fed a steam-flaked corn (“SFC”) and alfalfa hay starting diet. In some embodiments, the ruminal pH of an animal fed an animal feed ration of the present disclosure as a starting diet may be about 0.25 to about 1.5 pH units higher than the ruminal pH of an animal fed an SCF starting diet. In some embodiments, the higher ruminal pH may be present for about 1 to about 3 days after starting feeding of an animal feed ration of the present disclosure.

Consumption of small meals and more frequent consumption of meals throughout the day can result in a more stable rumen pH and microbial environment and thus maintain good rumen health. The more consistent ruminal pH may result in increased animal weight gain.

Rumen health benefits and consumption behavior of feedlot cattle started on a feed ration of the present disclosure can result in improved animal performance impacts over the entire feeding period. Rumen pH for cattle started on a feed ration of the present disclosure during an initial feeding period and when a high grain finishing ration is first introduced may be higher and more stable than with a traditional high-roughage feeding approach.

Feed intake patterns of cattle started on feed ration of the present disclosure may be different than feed intake patterns of cattle fed an SFC and alfalfa hay starting diet. Cattle fed a feed ration of the present disclosure may tend to eat smaller, more frequent meals, over more hours of the day. Cattle fed a feed ration of the present disclosure may have feed intake similar to cattle fed an SFC and alfalfa hay starting diet during daylight hours, but may consume more feed during overnight hours, with consistent intake pattern lasting through the night and into the morning, resulting in a more stable rumen environment and greater total feed intake

In some embodiments, an animal fed according to methods of the present disclosure may have a ruminal pH higher than that of an animal fed a steam-flaked corn and alfalfa hay starting diet. In some embodiments, an animal fed according to methods of the present disclosure may have a feed intake that is higher than that of an animal fed a steam-flaked corn and alfalfa hay starting diet. In some embodiments, the feed intake may be at least about 1% or at least about 2% higher. In some embodiments, an animal fed according to methods of the present disclosure may experience a weight gain that is higher than that of an animal fed a steam-flaked corn and alfalfa hay starting diet.

### Examples

Comparison of RAMP as a Starting Diet with a Traditional Steam-Flaked Corn and Alfalfa Hay Starting Diet while Transitioning to Steam-Flaked Corn (“SFC”)/Silage Finishing Ration

Method:

Start with cattle that have been fed a high roughage diet, withhold feed for 24 hours to simulate transit of cattle into a feedyard, and then directly provide free access to RAMP® starter, SFC/alfalfa hay starter, and finisher diet. Measurements are made of ruminal pH, volatile fatty acids, and feed intake as cattle are adjusted to a SFC/silage finishing diet.

Two treatments: three calves on RAMP® starter feed and three calves on traditional starter feed. Calves are kept without feed for 24 hours before offered feed to simulate trucking. Feed intake data are collected by suspending feedbunks from load cells (scales). Scales record bunk readings when there is change in weight of at least 0.5 lbs; readings are average for every 5 minutes. A meal is considered completed when there is a period of at least 10 min with no activity at the bunk. The rumen pH of the calves is measured as described in “Evaluation of sensors for monitoring rumen pH, temperature and pressure,” by Lin et al., Proceedings of the New Zealand Society of Animal Production, Volume 70, pp 71-76, June 2010. Briefly, the rumen pH was measured continuously using a wireless pH and temperature bolus, model KR2002 (Kahne Limited, Auckland, New Zealand) placed in the rumen of each calf. pH data collected from the boluses are transmitted to a computer and converted to a graph of ruminal pH vs. time.

The composition of traditional starter feed and finisher feed are shown in Table 2. The composition of RAMP® starter feed is shown in Table 3.

TABLE 2
Composition of Traditional Starter Feed and Finisher Feed

| | Traditional Starter | Finisher |
|---|---|---|
| DM basis % | Feed* | Feed** |
| Alfalfa Hay | 40.0 | 4.7 |
| Steam Flaked Corn | 28.6 | 43.5 |
| Corn Silage | | 4.3 |
| Corn DDGS | 10.9 | 20.2 |
| High Moisture Corn | 16.8 | 23.0 |
| Starter Supplement | 3.7 | |
| Finisher Supplement | | 4.2 |

*Starter at 20 g/ton of monensin DM basis with starter supplement at 535 g/ton DM basis.
**Finisher at 30 g/ton of monensin DM basis with finisher supplement at 707 g/ton DM basis.

TABLE 3
Composition of RAMP ® Starter Feed

| | As-Fed | | Dry Matter | |
|---|---|---|---|---|
| Ingredient | Basis | | Basis | |
| Dry Matter* | 63.0% | | 100% | |
| Protein | 13.0% | | 20.6% | |
| Fat | 2.2% | | 3.5% | |
| Crude Fiber | 7.6% | | 12.0% | |
| ADF | 10.1% | | 16.0% | |
| NDF | 20.8% | | 33.0% | |
| Calcium | 0.88% | | 1.40% | |
| Phosphorus | 0.57% | | 0.90% | |
| Potassium | 0.88% | | 1.40% | |
| Magnesium | 0.25% | | 0.40% | |
| Sodium | 0.19% | | 0.30% | |
| Sulfur | 0.25% | | 0.40% | |
| Cobalt | 0.2 | ppm | 0.3 | ppm |
| Copper | 13 | ppm | 20 | ppm |
| Iron | 63 | ppm | 100 | ppm |
| Manganese | 45 | ppm | 72 | ppm |
| Molybdenum | 0.2 | ppm | 0.4 | ppm |
| Zinc | 76 | ppm | 120 | ppm |

*Processed grain by-products, condensed corn fermentation solubles, alfalfa hay, cottonseed hulls, calcium carbonate, trace mineral premix (1 lb per ton containing 16.35% Ca, 5.5% Mn, 7.0% Zn, 1.8% Cu, 1100 ppm I, 360 ppm Co, 360 ppm Se), vitamin premix (0.13 lb per ton containing 81,000 IU vitamin A, 8,100 IU vitamin D, and 73.4 IU vitamin E per gram premix), artificial color, and 20 g/ton monensin DM basis.

The feeding schedule and % split of starter and finisher rations (i.e., the % of total diet fed at each daily feeding, where 100% is the total amount of feed offered per day) fed in each of three feedings during periods 1-5 are shown in Table 4.

TABLE 4
Feeding Schedule and % Split of Ration in Daily Feedings

| Period | 1 | 2 | 3 | 4 | 5 |
|---|---|---|---|---|---|
| Number of | 7 | 5 | 5 | 5 | 7 |
| Days | | | | | |
| Daily | | | | | |
| Feedings: | | | | | |
| First | 33.3% | 37.5% | 25% | 37.5% | 33.3% |
| Feeding | starter | starter | starter | finisher | finisher |
| Second | 33.3% | 25% | 50% | 25% | 33.3% |
| Feeding | starter | finisher | finisher | starter | finisher |
| Third | 33.3% | 37.5% | 25% | 37.5% | 33.3% |
| Feeding | starter | starter | starter | finisher | finisher |

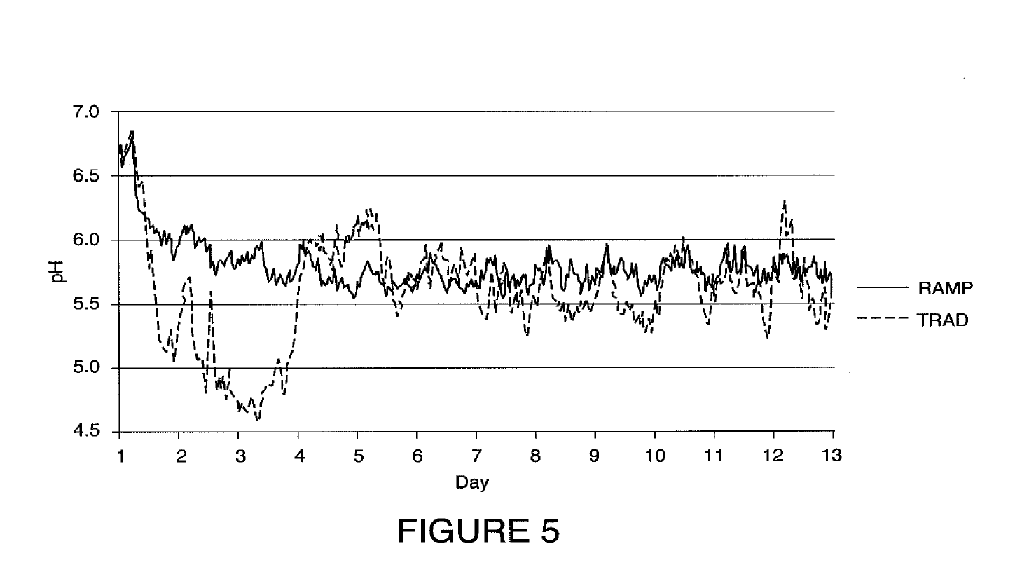

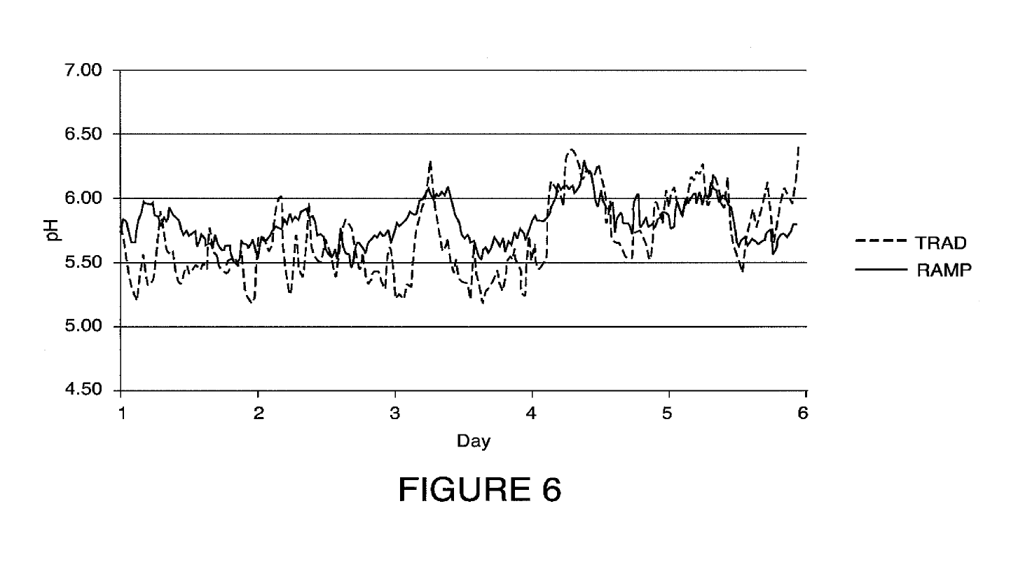

As shown in FIGS. 5 and 6, during the first two periods, calves fed RAMP® as a starter feed had more uniform ruminal pH curves and fermentation end product patterns, and less drop of pH after feeding as compared to calves fed the traditional starter feed.

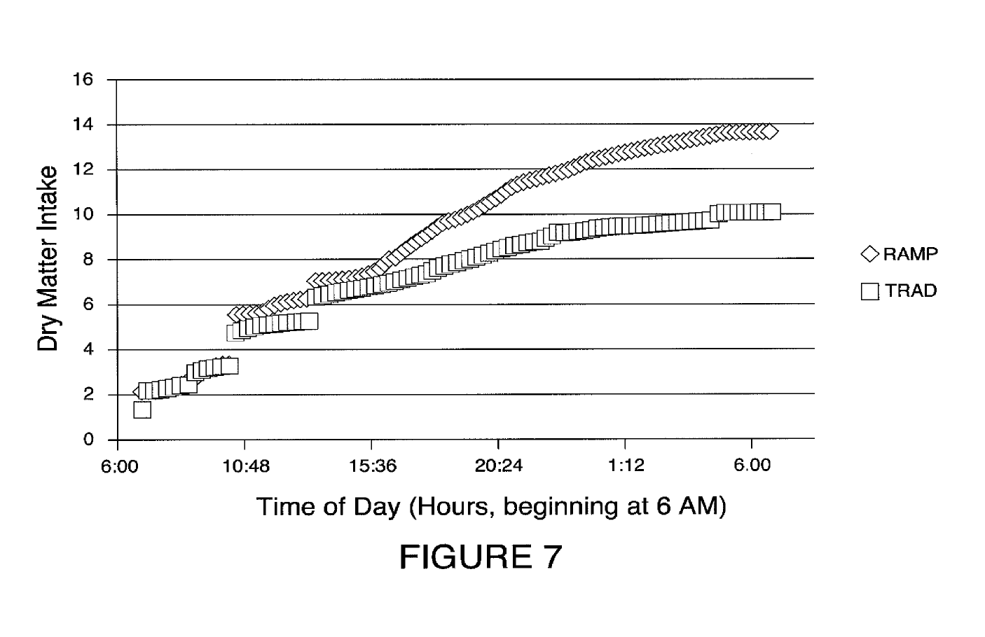

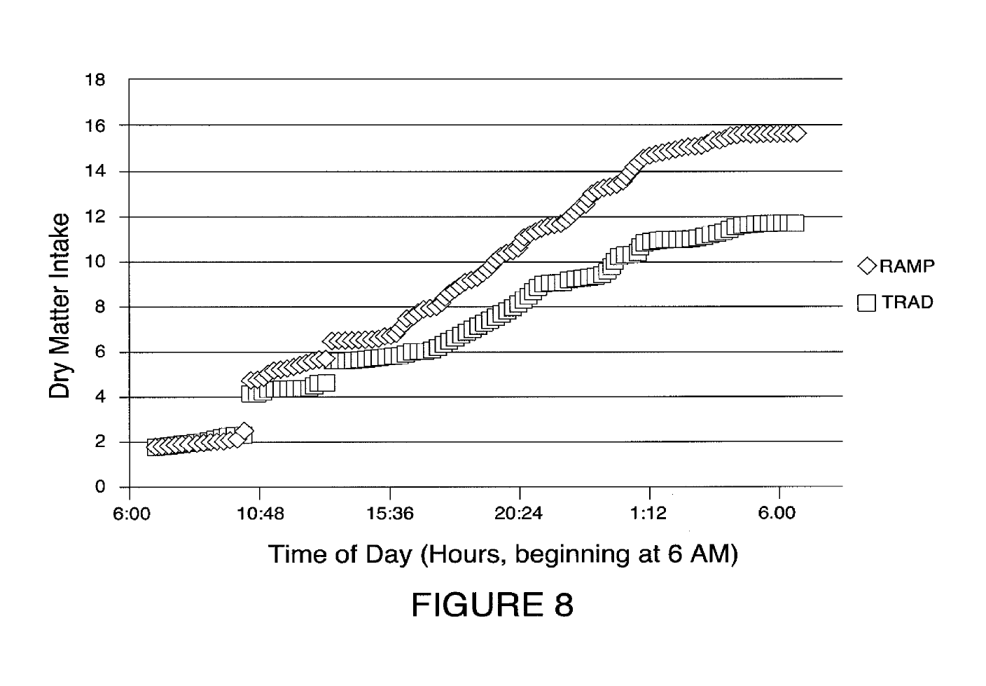

FIGS. 7 and 8 show dry matter intake of calves fed RAMP® as a starter feed and calves fed the traditional starter feed in Periods 1 and 2, respectively. Referring to FIGS. 7 and 8, it was observed that for calves fed RAMP® as a starter feed, more feed was left over during the day but more consumption occurred in the late afternoon and at the end of day as compared to calves fed the traditional starter feed.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. When the claims use the word “or” in reference to a list of two or more items, that word covers all of the following interpretations of the word: any of the items in the list, all of the items in the list, and any combination of the items in the list.

The above detailed descriptions of embodiments of the invention are not intended to be exhaustive or to limit the invention to the precise form disclosed above. Although specific embodiments of, and examples for, the invention are described above for illustrative purposes, various equivalent modifications are possible within the scope of the invention, as those skilled in the relevant art will recognize. For example, while steps are presented in a given order, alternative embodiments may perform steps in a different order. The various embodiments described herein can also be combined to provide further embodiments.

In general, the terms used in the following claims should not be construed to limit the invention to the specific embodiments disclosed in the specification, unless the above detailed description explicitly defines such terms. While certain aspects of the invention are presented below in certain claim forms, the inventors contemplate the various aspects of the invention in any number of claim forms. Accordingly, the inventors reserve the right to add additional claims after filing the application to pursue such additional claim forms for other aspects of the invention.

1.-30. (canceled)

31. An animal feed composition comprising high moisture feed, roughage, micro ingredients and taggant.

32. The composition of claim 31, wherein the high moisture feed comprises corn gluten feed.

33. The composition of claim 31, wherein the roughage comprises at least one of alfalfa hay and cottonseed hulls.

34. The composition of claim 31, wherein the high moisture feed comprises corn gluten feed and the roughage comprises at least one of alfalfa hay and cottonseed hulls.

35. The composition of claim 32, wherein the corn gluten feed comprises about 75-90 wt % by weight of the composition.

36. The composition of claim 34, wherein the corn gluten feed comprises about 75-90 wt % by weight, the at least one of alfalfa hay and cottonseed hulls comprises about 5-20 wt % and the micro ingredients comprises 2-3 wt %.

37. The composition of claim 34, wherein the corn gluten feed comprises about 60-85 wt % by weight, the at least one of alfalfa hay and cottonseed hulls comprises about 5-20 wt % and the micro ingredients comprises 2-3 wt %.

38. The composition of claim 31, wherein the taggant is a marker or one or more dyes.

39. The composition of claim 31, wherein the taggant is a different color than the high moisture feed, roughage and micro ingredients.

40. The composition of claim 31, wherein the taggant is one or more dyes selected from the group consisting of indigo carmine, methylene blue, tartrazine, laccaic acid, beta-carotene, FD&C Blue No. 1, FD&C Blue No. 2, FD&C Green No. 3, FD&C Red No. 3, FD&C Red No. 40, FD&C Yellow No. 6 and riboflavin.

41. The composition of claim 31, wherein the taggant is FD&C Blue No. 1.

42. The composition of claim 31, wherein the composition further comprises nutrients.

43. The composition of claim 42, wherein the nutrients further comprise crude protein in the amount of at least 13 wt %, crude fat in the amount of at least 1.5 wt %, crude fiber in the amount of no more than 9.0 wt %, ADF in the amount of no more than 12.0 wt %, calcium in the amount of about 0.065 to about 1.15 wt % and phosphorus in the amount of at least 0.50 wt %.

44. The composition of claim 31, wherein composition comprises less than about 2% calcium.

45. The composition of claim 31, wherein the composition is a solid feed.

46. The composition of claim 31, wherein the composition is a complete feed.

47. The composition of claim 31, wherein the composition is an animal starter feed.

48. An animal starter feed comprising corn gluten feed, roughage, micro nutrients, and taggant and wherein the roughage comprises at least one of alfalfa hay and cottonseed hulls.

49. The animal starter feed of claim 48, wherein the corn gluten feed comprises about 75-90 wt % by weight, the at least one of alfalfa hay and cottonseed hulls comprises about 5-20 wt %, and the micro ingredients comprises 2-3 wt %.

50. A method of making an animal feed composition comprising:
combining high moisture feed, roughage, micro ingredients, and taggant.
